(19) United States
(12) Patent Application Publication
(10) Pub. No.: US 2026/0212565 A1
(43) Pub. Date: Jul. 23, 2026

(54) VIDEO GENERATION METHOD, ELECTRONIC DEVICE AND NON-TRANSITORY MEDIUM

(71) Applicant: Beijing Zitiao Network Technology Co., Ltd., Beijing (CN)

(72) Inventors: Yunhao LIAO, Beijing (CN); Sixue LIU, Beijing (CN); Xingxing WANG, Beijing (CN)

(21) Appl. No.: 19/454,078

(22) Filed: Jan. 20, 2026

(30) Foreign Application Priority Data
Jan. 20, 2025 (CN) 202510088988.X

(51) Int. Cl. G06T 11/60; G06V 20/40

(52) U.S. Cl. CPC G06T 11/60; G06V 20/41

(57) ABSTRACT

The present disclosure provides a video generation method, an electronic device and a non-transitory storage medium. The method includes: receiving a first image in response to a trigger operation for generating a first video and determining a second image associated with the first image, where picture content of the second image is related to picture content of the first image; determining a first transition video from the first image to the second image according to image size data of the first image and the second image; and displaying the first image, the first transition video, and the second image in sequence to obtain a first effect video.

### CROSS-REFERENCE TO RELATED APPLICATION(S)

This application claims the priority to and benefits of the Chinese Patent Application No. 202510088988.X, which was filed on Jan. 20, 2025. The aforementioned patent application is hereby incorporated by reference in its entirety.

### TECHNICAL FIELD

Embodiments of the present disclosure relate to the field of computer processing technologies and, in particular, to a video generation method, an electronic device and a non-transitory storage medium.

### BACKGROUND

With the development of network technologies, more and more applications have entered users' lives, especially props that may generate effect videos or short videos.

At present, an effect video may be generated based on two images uploaded by a user or an effect image generated based on one image uploaded by the user. There may be a problem that the generated effect video has disproportionate picture proportions and the video pictures have a harsh transition due to inconsistent picture proportions of the two images.

### SUMMARY

Embodiments of the present disclosure provide a video generation method, an electronic device and a non-transitory storage medium and a product to achieve smooth transition of video pictures, thereby improving a picture display effect.

An embodiment of the present disclosure provides a video generation method, including:
receiving a first image in response to a trigger operation for generating a first video and determining a second image associated with the first image, where picture content of the second image is related to picture content of the first image;
determining a first transition video from the first image to the second image according to image size data of the first image and image size data of the second image; and
displaying the first image, the first transition video, and the second image in sequence to obtain a first effect video.

An embodiment of the present disclosure further provides a video generation apparatus, including: a second image determination module, configured to receive a first image in response to a trigger operation for generating a first video and determine a second image associated with the first image, where picture content of the second image is related to picture content of the first image;
a transition video determination module, configured to determine a first transition video from the first image to the second image according to image size data of the first image and image size data of the second image; and
an effect video determination module, configured to display the first image, the first transition video, and the second image in sequence to obtain a first effect video.

An embodiment of the present disclosure further provides an electronic device, including:
one or more processors; and
a storage apparatus, configured to store one or more programs,
where the one or more programs, when executed by the one or more processors, cause the one or more processors to implement the video generation method as described in any one of embodiments of the present disclosure.

An embodiment of the present disclosure further provides a non-transitory storage medium including computer-executable instructions that, when executed by a computer processor, are configured to perform the video generation method as described in any one of embodiments of the present disclosure.

### BRIEF DESCRIPTION OF DRAWINGS

The above and other features, advantages, and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale.

FIG. 1 is a schematic flowchart of a video generation method according to an embodiment of the present disclosure;

FIG. 2 is a schematic diagram of a first image, a second image, and some video frames of a first transition video according to an embodiment of the present disclosure;

FIG. 3 is a schematic diagram of another first image, another second image, and some video frames of another first transition video according to an embodiment of the present disclosure;

FIG. 4 is a schematic flowchart of another video generation method according to an embodiment of the present disclosure;

FIG. 5 is a schematic diagram of determining a gradient size range of a first image according to an embodiment of the present disclosure;

FIG. 6 is a schematic diagram of a size change function according to an embodiment of the present disclosure;

FIG. 7 is a schematic flowchart of another video generation method according to an embodiment of the present disclosure;

FIG. 8 is a schematic diagram of displaying a first image, a second image, and the first image and the second image in a first display region according to an embodiment of the present disclosure;

FIG. 9 is a schematic diagram of a ratio change rate determination function according to an embodiment of the present disclosure;

FIG. 10 is a schematic structural diagram of a video generation apparatus according to an embodiment of the present disclosure; and

FIG. 11 is a schematic structural diagram of an electronic device according to an embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein; on the contrary, these embodiments are provided for a more thorough and complete understanding of the present disclosure. It should be understood that the drawings and embodiments of the present disclosure are only for exemplary purposes and are not intended to limit the protection scope of the present disclosure.

It should be understood that steps described in method implementations of the present disclosure may be performed in different orders and/or in parallel. Furthermore, the method implementations may include additional steps and/or omit performing illustrated steps. The scope of the present disclosure is not limited in this respect.

As used herein, the term “include/comprise” and variations thereof are open-ended inclusions, that is, “include/comprise but not limited to”. The term “based on” is “at least partially based on”. The term “an embodiment” means “at least one embodiment”; the term “another embodiment” means “at least one another embodiment”; the term “some embodiments” means “at least some embodiments”. Relevant definitions of other terms are given in the description below.

It should be noted that concepts such as “first” and “second” mentioned in the present disclosure are only used to distinguish different apparatuses, modules, or units, and are not used to limit the order of functions performed by these apparatuses, modules, or units or interdependence therebetween.

It should be noted that modifications of “a” and “a plurality of” mentioned in the present disclosure are illustrative rather than restrictive, and those skilled in the art should understand that unless otherwise explicitly specified in the context, they should be understood as “one or more”.

The names of messages or information exchanged between a plurality of apparatuses in implementations of the present disclosure are only for illustrative purposes, and are not intended to limit the scope of these messages or information.

It may be understood that before using the technical solutions disclosed in the embodiments of the present disclosure, the user should be informed of the type, range of use, use scenarios, etc. of personal information involved in the present disclosure in an appropriate manner in accordance with relevant laws and regulations, and the authorization of the user should be obtained.

For example, in response to receiving an active request from a user, prompt information is sent to the user to clearly inform the user that the requested operation will require access to and use of the user's personal information. In this manner, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It should be understood that the above process of notifying the user and acquiring the authorization of the user is only illustrative and does not constitute a limitation on the implementations of the present disclosure, and other manners that satisfy relevant laws and regulations may also be applied to the implementations of the present disclosure.

It should be understood that data involved in the technical solution (including but not limited to the data itself, acquisition or use of the data) should comply with requirements of corresponding laws, regulations, and related provisions.

Before the technical solution is described, an application scenario may be exemplarily described. The solution provided in the embodiments of the present disclosure may be applied to any scenario in which two or more images need to be displayed with a transition therebetween. Based on the solution provided in the embodiments of the present disclosure, a first transition video corresponding to a transition between any two images may be determined, and a first effect video may be generated based on the first transition video and the any two images.

Exemplarily, in response to that there are an image A, an image B, and an image C, and the images to be displayed in sequence are the image A, the image B, and the image C, a first transition video 1 between the image A and the image B and a first transition video 2 between the image B and the image C may be respectively determined based on the solution according to the embodiments of the present disclosure. A first effect video is generated based on the image A, the first transition video 1, the image B, the first transition video 2, and the image C.

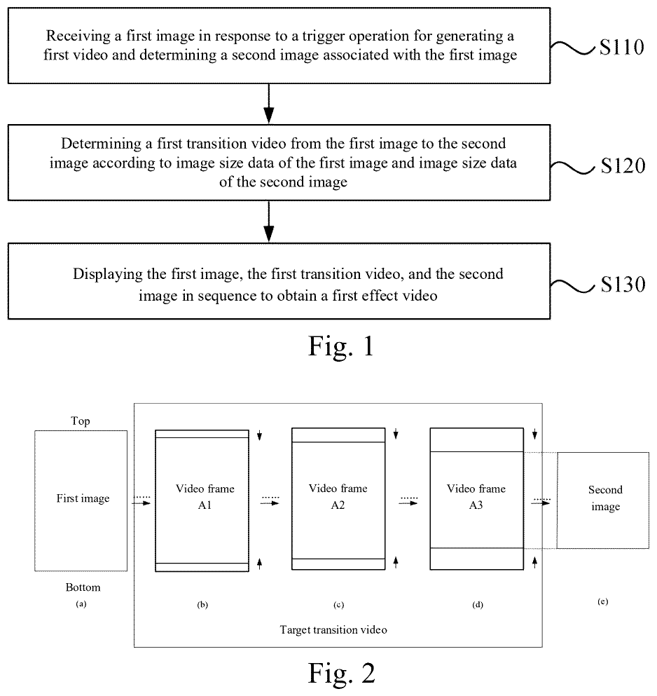

In order to describe the technical solution more clearly, the following uses an example of any two images to illustrate how to generate a first transition video and how to generate a first video based on the first transition video. FIG. 1 is a schematic flowchart of a video generation method according to an embodiment of the present disclosure. The embodiment of the present disclosure is applicable to any scenario in which two images need to be displayed with a transition therebetween. The method may be performed by a video generation apparatus, which may be implemented in the form of software and/or hardware, optionally, in an electronic device, which may be a mobile terminal, a PC, a server, etc.

As shown in FIG. 1, the method in this embodiment may specifically include the following steps S110, S120 and S130.

At step S110, receive a first image in response to a trigger operation for generating a first video and determining a second image associated with the first image.

Based on the solution according to the embodiments of the present disclosure, corresponding effect props may be integrated and applied to an existing application. In response to detect a trigger operation on the effect props, the trigger operation may be received in the background, that is, the effect props for generating the first video is invoked. At this time, effect data for generating the first video is integrated into the effect props. That is, in response to that the trigger operation on the effect props, it is considered that the trigger operation for generating the first video is triggered. The first image may be understood as an image to be displayed in a first video frame of the first video. The first image may be an image uploaded by the user, an image shot by invoking a camera apparatus after the trigger operation for generating the first video is triggered, or an image allocated by the system. Correspondingly, the first image may be an original image in the first transition video. The first video is an effect video to be generated.

In this embodiment, the first image may be determined through at least three obtaining methods described below.

In a first method, the first image may be an image shot in real time. After the user triggers a control for generating the first video, a camera apparatus integrated in a mobile terminal may be invoked to shoot the first image based on the camera apparatus.

In a second method, the first image may be an image shot in advance, that is, may be an image in an image library. After it is detected that the operation for generating the first video is triggered, an application for caching images or an application for a gallery may be invoked to display the image library, and the first image is determined based on a selection operation of the user in the image library.

In a third method, the first image may be an image downloaded from a cloud. For example, after it is detected that the operation for generating the first video is triggered, the image stored in the cloud may be automatically displayed, and the image stored in the cloud is displayed on a display interface. The first image is determined based on a trigger operation of the user on the displayed image.

The second image may be an image to be displayed after the first transition video is completely displayed. In particular, the picture content of the second image is related to the picture content of the first image. For example, the second image may be an image generated by processing the first image based on an existing image generation model. The image generation model may be a pre-trained model for generating a certain style type, and optionally, the style type may be a type displayed by an analog crystal ball. Certainly, the second image may also be an image that is found from all open source image libraries and related to the image content of the first image by the system based on the image content of the first image after the uploading of the first image is completed. Being related to the image content of the first image may be that the similarity between each image and the first image is respectively calculated, and the image with the highest similarity is used as the second image. At this time, the image content of the second image may be similar to the image content of the first image, or the image style type of the second image is similar to the image style type of the first image, or the image content and the style type of the second image are similar to the image content and the style type of the first image. Specifically, in response to detect that the effect props for generating the first video is triggered, that is, the operation for generating the first video is triggered, at this time, the user may select the first image. At the same time, loading information is displayed on the display interface, and the second image corresponding to the first image may be determined in the background.

In this embodiment, the second image associated with the first image may be determined in at least two manners described below. In a first manner, the first image is processed based on a stylization processing model to obtain the second image of a preset style type. In a second manner, the uploaded second image is received. In a third manner, the second image may be determined based on the first image and an open source image library.

Specifically, the stylization processing model is a pre-trained model for generating the preset style type. The stylization processing model may be encapsulated as a resource data in the effect props, so that in response to that the effect props is triggered, the first image may be stylized based on the stylization processing model to generate the second image. That is, the second image is obtained based on an image-to-image model. The second manner may be understood that the user may upload the second image according to actual needs. The third manner may be: the second image may also be an image that is found from all open source image libraries and related to the image content of the first image by the system based on the image content of the first image after the uploading of the first image is completed. Being related to the image content of the first image may be that the similarity between each image and the first image is respectively calculated, and the image with the highest similarity is taken as the second image. At this time, the image content of the second image may be similar to the image content of the first image, or the image style type of the second image is similar to the image style type of the first image, or the image content and the style type of the second image are similar to the image content and the style type of the first image.

After the first image is received, the first image may be displayed on the display interface. At this time, the first image may be displayed in the following manner: the first image is rendered to a first display region according to image size data of the first image and canvas size data of the first display region and then displayed.

The first display region screen is a canvas to which the first image and the second image are rendered, and the canvas (Canvas) refers to an area for drawing graphics and displaying content. The image size data includes at least one of a first width Wo, a first height Ho, and a first aspect ratio ro of the first image. The canvas size data includes at least one of a second width Ws, a second height Hs, and a second aspect ratio rs of the first display region.

In this embodiment, different image rendering manners may be selected according to the size numerical relationship between the image size data of the first image and the canvas size data of the first display region, and the first image is rendered onto the first display region for display according to the selected image rendering manner. In this manner, the first image may be clearly and comprehensively displayed to the user, and the purpose of displaying the complete image to the user is achieved.

Specifically, the first image may be rendered to the first display region according to the image size data of the first image and the canvas size data of the first display region in the following specific implementation: in response to an event that the first aspect ratio in the image size data of the first image is less than the second aspect ratio in the canvas size data, the first image is cropped according to the second aspect ratio and then rendered onto the first display region; and in response to an event that the first aspect ratio is greater than or equal to the second aspect ratio, the first image is rendered onto the first display region and a pixel point on the first display region where the first image is not presented is preset to a preset pixel value. The center coordinate of the first image is aligned with the center coordinate of the first display region.

The preset pixel value is a preset pixel value. For example, the preset pixel value may be a pixel value 0 corresponding to black. In this embodiment, in response to that the first aspect ratio ro in the image size data of the first image is less than the second aspect ratio rs in the canvas size data, in this case, the first image is narrower than the first display region, the image center point of the first image may be aligned with the center point of the first display region, and the upper and lower sides of the first image are respectively cropped according to the second aspect ratio of the first display region, so that the first image may fully occupy the entire first display region. In response to that the first aspect ratio ro in the image size data of the first image is greater than or equal to the second aspect ratio rs in the canvas size data, for example, the first aspect ratio is 1, and the second aspect ratio r is 3/4, in this case, the first image is wider than the first display region, and the first image may be rendered onto the first display region by filling the first image, that is, the pixel value of the region on the first display region where the first image is not displayed is presented as the preset pixel value.

It may be understood as that the first image may be drawn onto the first display region based on the above two constraints.

At step S120, determine a first transition video from the first image to the second image according to the image size data of the first image and the image size data of the second image.

The first transition video is a video in which the first image and the second image are in transitional connection. Through the first transition video, the visual sense of the first image changing to the second image is smoother and more natural. The image size data of the second image includes at least one of a third width Wt, a third height Ht, and a third aspect ratio rt of the second image.

In this embodiment, an adaptable transition video determination manner may be determined according to the size relationship between the first aspect ratio in the image size data of the first image and the third aspect ratio in the image size data of the second image. For example, the transition video determination manners may include a first transition video determination manner and a second transition video determination manner.

Specifically, the first transition video may be related to the first transition video determination manner, the first transition video is to display a preset pixel value from a top of the first image in a first direction and display the preset pixel value from a bottom of the first image in a second direction, and the first transition video determination manner corresponds to the first aspect ratio of the first image being less than the third aspect ratio of the second image.

In this embodiment, in response to that the first aspect ratio of the first image is less than the third aspect ratio of the second image, the first transition video from the first image to the second image is generated according to the first transition video determination manner. At this time, the first transition video is to display the preset pixel value from the top of the first image in the first direction and display the preset pixel value from the bottom of the first image in the second direction.

Exemplarily, for a schematic diagram of the first image, the second image, and some video frames of the first transition video, see FIG. 2. The first aspect ratio of the first image is 3/4, and the third aspect ratio of the second image is 1. In this case, the first transition video may be generated by using the first transition video determination manner. As shown in FIG. 2, (a) of FIG. 2 shows the first image with the first aspect ratio of 3/4, and (e) FIG. 2 shows the second image with the third aspect ratio of 1. (b) to (d) of FIG. 2 show some video frames of the first transition video, where the image content other than the preset pixel value in the last video frame of the first transition video is consistent in height with the second image. Next, the transition video frame shown in (b) of FIG. 2 is taken as an example to illustrate the specific meaning of each transition video frame in the first transition video. The preset pixel value may be set to a pixel value 0 corresponding to black, and the transition video frame shown in (b) of FIG. 2 represents a video frame obtained by displaying a certain number of preset pixel values downward from the top of the first image and displaying a certain number of preset pixel values upward from the bottom of the first image. It should be particularly noted that the specific meanings of the remaining transition video frames in the first transition video are consistent with the meaning of the transition video frame shown in (b) of FIG. 2, and details are not described herein again.

Specifically, the first transition video may also be related to the second transition video determination manner, the first transition video is a video in which a local area of the first image is sequentially magnified, and the second transition video determination manner corresponds to the first aspect ratio of the first image being greater than or equal to the third aspect ratio of the second image.

In this embodiment, in response to that the first aspect ratio of the first image is greater than or equal to the third aspect ratio of the second image, the first transition video for switching from the display of the first image to the second image is generated according to the second transition video determination manner. At this time, the first transition video is a video in which the local area of the first image is sequentially magnified.

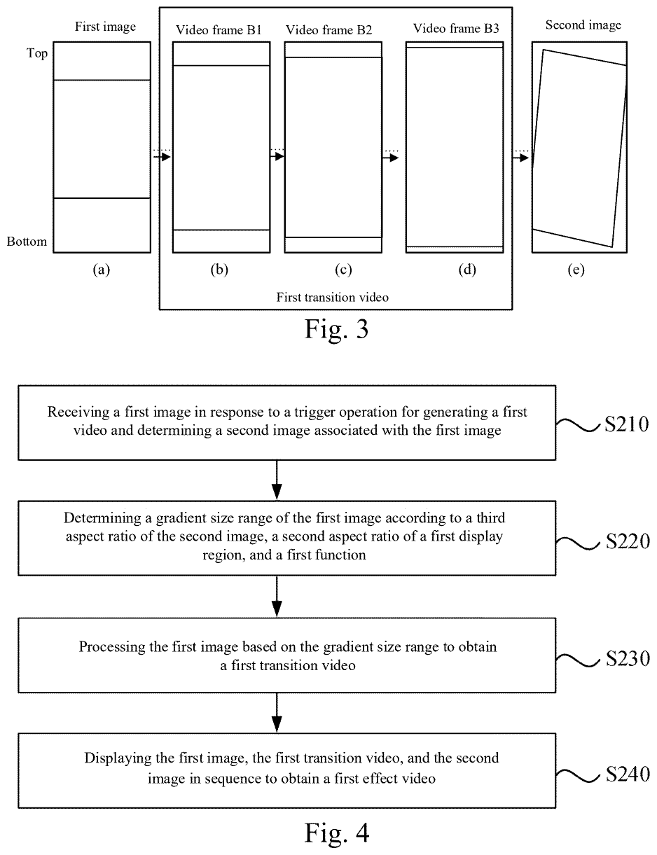

Exemplarily, for a schematic diagram of the first image, the second image, and some video frames of the first transition video, see FIG. 3. The first aspect ratio of the first image is 3/4, and the third aspect ratio of the second image is 9/16. In this case, the first transition video may be generated by using the second transition video determination manner. As shown in FIG. 3, (a) of FIG. 3 shows the first image with the first aspect ratio of 3/4, and (e) of FIG. 3 shows the second image with the third aspect ratio of 9/16. (b) to (d) of FIG. 3 show some video frames of the first transition video, and the last transition video frame of the first transition video is consistent in height with the second image. The first image may be scaled proportionally according to a first scaling ratio, and the proportionally scaled first image is sampled according to the texture coordinates of the sampling points in the first display region. As shown in FIG. 3, the video frame B1 shown in (b) of FIG. 3 is a video frame obtained by locally magnifying the image content in (a) of FIG. 3, the video frame B2 shown in (c) of FIG. 3 is a video frame obtained by locally magnifying the image content in (b) of FIG. 3, and the video frame B3 shown in (d) of FIG. 3 is a video frame obtained by locally magnifying the image content in (c) of FIG. 3. In the process of magnifying the first image, the display area of the first image in the first display region is gradually increased. It should be particularly noted that the first transition video includes multiple video frames, and the video frame B1, the video frame B2, and the video frame B3 shown in FIG. 3 are only some examples.

In this embodiment, in response to that the first aspect ratio of the first image is less than the third aspect ratio of the second image, the first transition video in which the upper and lower black edges gradually appear is determined based on the first transition video determination manner. In response to that the first aspect ratio of the first image is greater than or equal to the third aspect ratio of the second image, the first transition video in which the original image is magnified to crop out the middle area is determined based on the second transition video determination manner. In this manner, for various cases where the size ratios of the first image and the second image are inconsistent, the corresponding first transition video determination manners are provided, and the efficiency of determining the first transition video is improved.

At step S130, display the first image, the first transition video, and the second image in sequence to obtain the first effect video.

The first image, the first transition video, and the second image are sequentially arranged according to the playing sequence of the first effect video. It should be noted that the image height of the last video frame of the first transition video is consistent with the image height of the second image.

In this embodiment, in a process of displaying the first transition video in the first effect video, the method further includes: displaying a first preset animation effect, where the preset animation effect is related to a style type of the second image.

It may be understood as that in order to further improve the harmony and smooth transition of the video pictures, a preset first animation effect may be displayed in the process of displaying the first transition video. Optionally, the first preset animation effect may be displayed in a bottom-up manner. The effect content of the first preset animation effect may be a trajectory that simulates a curvilinear motion or a meteor motion, and the display color or style type of the first preset animation effect may match the style type of the second image, so as to improve the coordination of the pictures.

In this manner, because the animation effect adaptable to the style type of the second image is synchronously displayed in the process of displaying the first transition video, when the second image is finally displayed, the problem of strong sense of fragmentation of the image content caused by a large difference in the displayed content is avoided, that is, the effect of coordinated transition of the picture content is improved.

Based on the preceding technical solution, after the second image is displayed, in order to avoid the problem of picture freeze, the method further includes: displaying the second image according to a second preset animation effect to update the first effect video.

The second preset animation effect is different from the first preset animation effect. The second preset animation effect may be an animation effect selected by the user from multiple optional animation effects, or may be a preset animation effect adaptable to the style type of the second image. Optionally, the second preset animation effect is an effect of magnifying and displaying the second image, or may be a schematic diagram of an effect of simulating that the lens for acquiring the second image is from far to near.

In this embodiment, the second image is displayed with the effect according to the preset second preset animation effect to obtain the updated first effect video. In this manner, the second image may be displayed vividly according to the preset animation effect, and the interestingness and the picture coordination of the first effect video are improved.

In the technical solution of the embodiments of the present disclosure, after receiving the first image in response to the trigger operation for generating the first video and determining the second image associated with the first image, the first transition video for switching from display the first image to the second image may be determined according to the image size data of the first image and the second image; and then the first image, the first transition video, and the second image are displayed in sequence to obtain the first effect video. In this manner, the first transition video adaptable to the first image and the second image may be determined according to the image size data of the first image and the second image, so that the smooth transition of the picture proportions may be achieved when the first image is transited to the second image, thereby improving the coordination of the picture content, and solving the problem of poor display effect of the picture content caused by the sudden change of the picture proportions when directly displayed in the prior art based on the first image and the second image.

FIG. 4 is a schematic flowchart of another video generation method according to an embodiment of the present disclosure. On the basis of the preceding embodiment, the technical solution of this embodiment describes in detail the specific implementation process of determining the first transition video based on the first transition video determination manner, and reference may be made to the detailed description of the embodiment of the present disclosure for the specific implementation. The technical features identical to or similar to those of the preceding embodiment are not repeated herein.

As shown in FIG. 4, the method in this embodiment may specifically include the steps S210, S220, S230 and S240 described below.

At step S210, receive a first image in response to a trigger operation for generating a first video and determining a second image associated with the first image.

In this embodiment, the first transition video may be determined based on a first transition video determination manner, or the first transition video may be determined based on a second transition video determination manner. In this embodiment, in response to that a first aspect ratio of the first image is less than a third aspect ratio of the second image, the first transition video may be determined based on the first transition video determination manner, and the specific implementation thereof mainly includes steps S220 to S240.

At step S220, determine a gradient size range of the first image according to the third aspect ratio, a second aspect ratio of a first display region, and a first function.

The gradient size range is used for representing a range of change from a top of the first image in a first direction and a range of change from a bottom of the first image in a second direction, and a pixel value in the range of change is a preset pixel value.

The first function is a function used for determining the gradient size range, and the first function may be expressed as:

$$UV . {V}_{b l a c k} = ( 1.0 - \frac{{r}_{s}}{{r}_{t}} ) * \frac{1}{2}$$

Where UV·V_{black} represents a gradient distance value for determining the gradient size range, rₛ represents the second aspect ratio of the first display region, and rₜ represents the third aspect ratio of the second image.

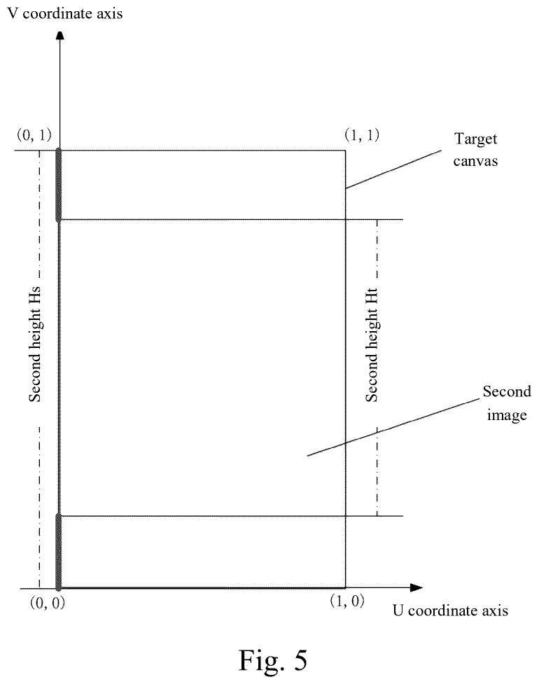

Next, the principle of the first function will be described. In this embodiment, the first display region is represented by a UV coordinate system, the horizontal axis of the UV coordinate system is a U coordinate axis, the vertical axis of the UV coordinate system is a V coordinate axis, and the coordinate value ranges of the U coordinate axis and the V coordinate axis are both 0 to 1. The implementation principle of displaying the first image on the first display region is to sample the pixel value of each of the pixel points of the first image and map the sampling values into the UV coordinate system of the first display region. For a schematic diagram of determining the gradient size range of the first image, see FIG. 5. The top of the first image is aligned with the top of the first display region, and the bottom of the first image is aligned with the bottom of the first display region. The gradient size range of the first image is shown by the bold line segment in FIG. 5, the bold line segment in the upper part of FIG. 5 refers to the range of change from the top of the first image in the first direction, which may be simply referred to as the first gradient size range, and the bold line segment in the lower part of FIG. 5 refers to the range of change from the bottom of the first image in the second direction, which may be simply referred to as the second gradient size range. It may be seen from FIG. 5 that in order to determine the specific values of the first gradient size range and the second gradient size range, the key lies in calculating the length of the bold line segment (i.e., the gradient distance value), and the actual meaning corresponding to the value of V_{black} in the first function is the length of the bold line segment.

In this embodiment, the first height of the first image may be expressed as Wₒ, the first height of the first image may be expressed as Hₒ, and the first aspect ratio of the first image may be expressed as rₒ=Wₒ/Hₒ. The second height of the first display region may be expressed as Wₜ, the second height of the first display region may be expressed as Hₜ, and the second aspect ratio of the first display region may be expressed as rₜ=W./Hₜ. The third height of the second image may be expressed as Wₛ, the third height of the second image may be expressed as Hₛ, and the third aspect ratio of the second image may be expressed as rₛ=Wₛ/Hₛ. It may be easily derived according to FIG. 5 that:

$$UV . {V}_{b l a c k} = ( 1.0 - \frac{{H}_{t}}{{H}_{s}} ) * \frac{1}{2}$$

Now that Wₜ=Wₛ, then rₛ*Hₛ=rₜ*Hₜ, so

$$\frac{{H}_{t}}{{H}_{s}} = \frac{{r}_{s}}{{r}_{t}}$$

It may be seen that

$$UV . {V}_{b l a c k} = ( 1.0 - \frac{{H}_{t}}{{H}_{s}} ) * \frac{1}{2} = ( 1. - \frac{{r}_{s}}{{r}_{t}} ) * \frac{1}{2} .$$

In this embodiment, by substituting the third aspect ratio and the second aspect ratio of the first display region into the first function, the gradient distance value may be calculated, and the range of change from the top of the first image in the first direction and the range of change from the bottom of the first image in the second direction may be derived. Exemplarily, the second aspect ratio rₛ of the first display region is 9/16, and the third aspect ratio rₜ of the second image is 1. Then, by substituting

$${r}_{s} = \frac{9}{16}$$

and rₜ=1 into the first function, it may be calculated that UV. V_{black}=0.21875, the range of change from the top of the first image in the first direction is V=1 to V=1−0.21875, and the range of change from the bottom of the first image in the second direction is V=0 to V=0.21875.

At step S230, process the first image based on the gradient size range to obtain the first transition video.

In this embodiment, the number of transition video frames included in the first transition video may be a set value, and the gradient size corresponding to each transition video frame may be determined by an interpolation method, an averaging method or the like according to the gradient size range. Thus, in the response that the gradient size corresponding to each transition video frame is obtained, the first transition video may be determined. In this embodiment, by determining the gradient size range, the degree of change of the first image may be quantitatively controlled, so that the first transition video may be accurately and efficiently determined.

Based on the preceding embodiments, the first image may be processed based on the gradient size range to obtain the first transition video in the following specific implementation: determining a first gradient size corresponding to at least one transition video frame in the first transition video based on the gradient size range, a preset frame rate, and a size change function; and processing the first image based on the first gradient size corresponding to the at least one transition video frame to obtain the first transition video.

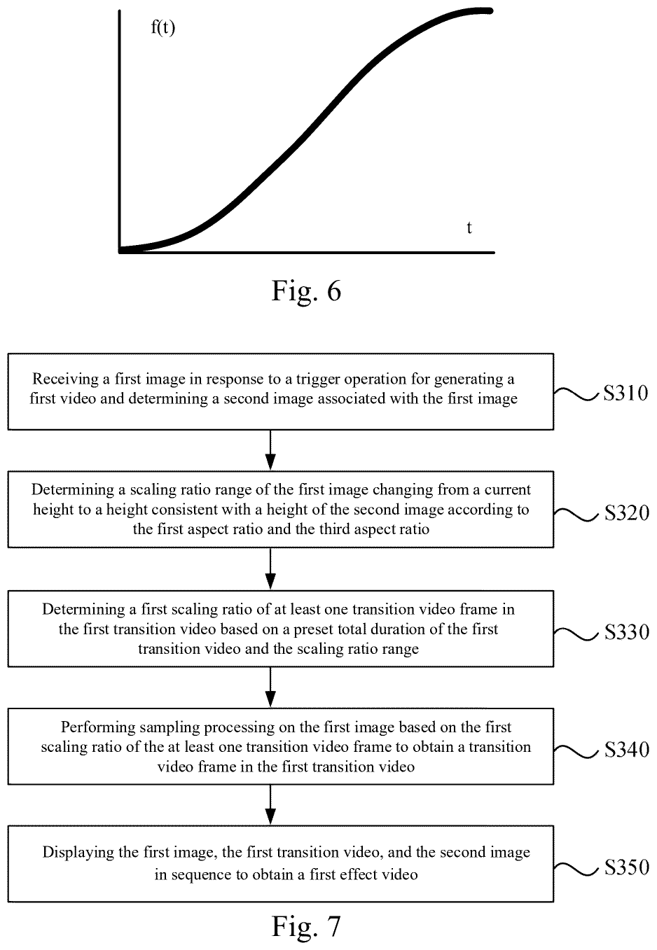

The preset frame rate refers to the preset number of transition video frames continuously appearing on the first display region per second. The first gradient size refers to the change amplitude of a certain transition video frame relative to the previous transition video frame. The size change function is used for determining the first gradient size corresponding to each transition video frame in the first transition video, that is, the size change function represents the change process of the gradient size with time. In this embodiment, the size change function may be expressed as the following easing formula:

$$f ( t ) = \frac{- ( cos ( π t ) - 1. )}{2}$$

where t represents any moment in the time range from the start moment to the end moment of the first transition video, and f(t) represents the function calculation value for determining the first gradient size of the transition video frame at the moment t. For the schematic diagram of the size change function, see FIG. 6. As shown in FIG. 6, the degree of change of the gradient size is small in the initial time period and the end time period of the size change function, and the degree of change of the gradient size is large in the middle time period of the size change function. In this manner, the first transition video determined according to the size change function may achieve the effect of slow fading in and out, and the abruptness of the transition may be reduced.

In this embodiment, the first gradient size corresponding to each transition video frame is determined, so that the pixel positions in each transition video frame where the pixel values should be set to the preset pixel value may be determined. Specifically, the first mapping relationship between the range of the size change function and the gradient size range may be determined according to the gradient size range; and for any current transition video frame, the first time information corresponding to the current transition video frame may be determined according to the preset frame rate and the sorting position of the current transition video frame, so that the function calculation value may be obtained by substituting the first time information into the size change function, and the first gradient size corresponding to the current transition video frame may be determined according to the function calculation value and the first mapping relationship. Based on the same processing manner, the first gradient size corresponding to each transition video frame may be obtained. Further, for each transition video frame, the pixel values in the top first gradient size range of the first image may be processed according to the corresponding first gradient size, and the pixel values in the bottom first gradient size range of the first image may be processed, so that the first transition video may be obtained.

More specifically, the first gradient size corresponding to the at least one transition video frame in the first transition video may be determined based on the gradient size range, the preset frame rate, and the size change function in the following specific implementation: determining, for the at least one transition video frame, an accumulated duration of the transition video frame based on the preset frame rate and a display position of the transition video frame in the first transition video; determining a first value to be input to the first size function based on the accumulated duration, a preset total duration of the first transition video, and a parameter range of the size change function; and substituting the first value into the size change function to determine the first gradient size of the transition video frame.

The first transition video may include N transition video frames, and the display position of the i-th transition video frame in the first transition video may be expressed as “i”. The accumulated duration of the transition video frame refers to the length of time from the display moment corresponding to a certain transition video frame to the initial moment of the first transition video.

In this embodiment, for each transition video frame in the first transition video, the first gradient size corresponding to each transition video frame is determined in the same manner. Here, any one of the transition video frames is used as an example for description. The preset frame rate may be 20 frames/second, and the display position of the transition video frame in the first transition video may be the 10th display position, so that the accumulated duration T10 corresponding to the transition video frame is 500 milliseconds; the preset total duration of the first transition video is 2 seconds, and the parameter range of the size change function is (0, 1). The ratio of the accumulated duration to the total duration of the first transition video is normalized according to the parameter range of the size change function, and the first value to be input to the first size function may be obtained as 0.25. Further, 0.25 may be substituted into the size change function for calculation, and the obtained calculation result is used for determining the first gradient size of the transition video frame.

At step S240, displaying the first image, the first transition video, and the second image in sequence to obtain the first effect video.

In the technical solution of the embodiment of the present disclosure, when the first transition video is determined based on the first transition video determination manner, the gradient size range of the first image is determined according to the third aspect ratio, the second aspect ratio of the first display region, and the first function. The gradient size range is used for representing the range of change from the top of the first image in the first direction and the range of change from the bottom of the first image in the second direction, and the pixel value in the range of change is the preset pixel value. Thus, the first image is processed based on the gradient size range to obtain the first transition video. In the technical solution of the embodiment of the present disclosure, by determining the gradient size range, the degree of change of the first image may be quantitatively controlled, so that the first transition video may be accurately and efficiently determined.

FIG. 7 is a schematic flowchart of another video generation method according to an embodiment of the present disclosure. Based on the preceding embodiments, the technical solution of this embodiment describes in detail the determination of the first transition video based on the second transition video determination manner, and reference may be made to the detailed description of the embodiments of the present disclosure for the specific implementation thereof. The technical features identical to or similar to those in the preceding embodiments are not repeated here.

As shown in FIG. 7, the method in this embodiment may specifically include steps S310 to S350. At step S310, receive a first image in response to a trigger operation for generating a first video

and determine a second image associated with the first image.

In this embodiment, in response to that a first aspect ratio of the first image is greater than or equal to a third aspect ratio of the second image, the first transition video is determined based on the second transition video determination manner in the following specific implementation mainly including steps S320 to S340.

At step S320, determine a scaling ratio range of the first image changing from a current height to a height consistent with a height of the second image according to the first aspect ratio and the third aspect ratio.

The scaling ratio range refers to the range in which the size of the first image is scaled up or down according to a certain ratio.

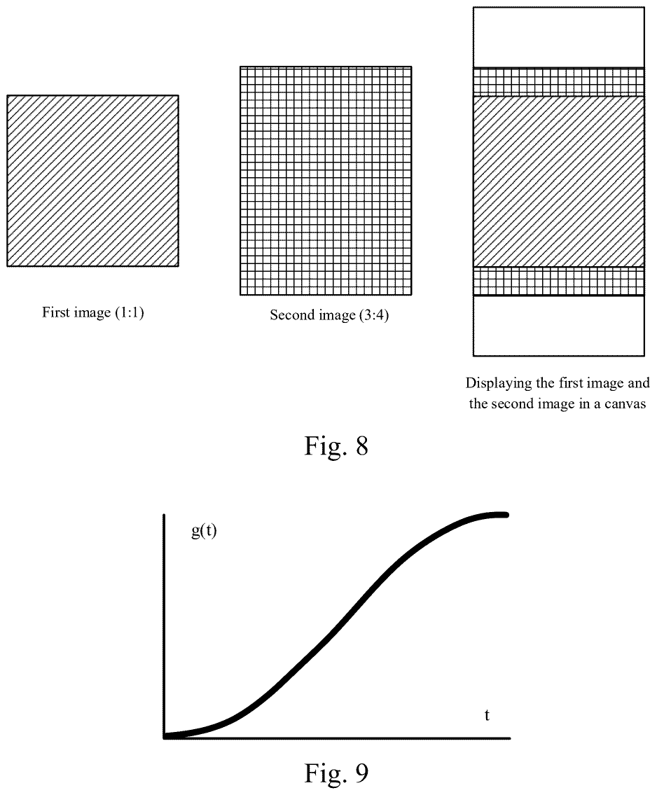

Specifically, because the first aspect ratio of the first image is greater than or equal to the third aspect ratio of the second image, the first image must be located within the range of the display region of the second image in a first display region. At this time, for the schematic diagram of displaying the first image, the second image, the first image, and the second image in the first display region, see FIG. 8. Based on this, the scaling ratio range in this embodiment refers to the range of the magnification ratio for scaling up the first image.

As shown in FIG. 8, in order to enable the first image to change from the current height to the height consistent with the height of the second image, the maximum scaling ratio s corresponding to the first image may be expressed as:

$$s = \frac{{H}_{t}}{{H}_{o}}$$

Because the first image and the second image are drawn on the first display region, the widths of the first image, the second image, and the first display region are the same, that is, Wₒ=Wₜ=Wₛ, where Wₒ=Hₒ*rₒ, Wₜ=Hₜ*rₜ, that is, Hₒrₒ=Hₜrₜ, from which it may be obtained that:

$$\frac{{H}_{t}}{{H}_{o}} = \frac{{r}_{o}}{{r}_{t}}$$

Based on this, the maximum scaling ratio s may be expressed as:

$$s = \frac{{r}_{o}}{{r}_{t}}$$

In this embodiment, the maximum scaling ratio s may be calculated according to the ratio of the first aspect ratio to the third aspect ratio. Based on this, the scaling ratio range of the first image changing from the current height to the height consistent with the height of the second image may be expressed as s′∈[1, s] and the scaling ratio range describes how to scale up the first image.

Exemplarily, in a practical application process, the first image needs to change the current magnification level s′ from 1 to s within a certain period of time. The specific calculation formula for the scaling-up process of the first image is:

$$1.0 + ( s - 1.0 ) * p$$

where p is the normalized value of s′, p∈[0, 1], and the calculation formula may be simply implemented with a mix function.

At step S330, determine a first scaling ratio of at least one transition video frame in the first transition video based on a preset total duration of the first transition video and the scaling ratio range.

The first scaling ratio refers to the scaling ratio of a certain transition video frame in the first transition video relative to the first image.

Specifically, for each transition video frame in the first transition video, the first scaling ratio corresponding to the transition video frame is determined in the same manner. Here, any one of the transition video frames is taken as an example for description. The first scaling ratio of a certain transition video frame may be determined by an interpolation method, an averaging method or the like based on the scaling ratio range and the number of transition video frames within the total duration of the first transition video. Based on the same processing manner, the first scaling ratio corresponding to each transition video frame may be determined.

Based on the preceding embodiments, the first scaling ratio of the at least one transition video frame in the first transition video may be determined based on the preset total duration of the first transition video and the scaling ratio range in the following specific implementation:
determining the first scaling ratio of the at least one transition video frame in the first transition video based on the total duration, the scaling ratio range, and a ratio change rate determination function.

The ratio change rate determination function is used for determining the first scaling ratio corresponding to each transition video frame in the first transition video, that is, the ratio change rate determination function represents the change process of the scaling ratio with time. In this embodiment, the ratio change rate determination function may be expressed as the following easing formula:

$$g ( t ) = \frac{- ( cos ( π t ) - 1. )}{2}$$

where t represents any moment in the time range from the start moment to the end moment of the first transition video, and g(t) represents the function calculation value for determining the first scaling ratio of the transition video frame at the moment t.

Specifically, the second mapping relationship between the range of the ratio change rate determination function and the scaling ratio range may be determined according to the scaling ratio range; and for any current transition video frame, the first time information corresponding to the current transition video frame may be determined according to the preset frame rate and the sorting position of the current transition video frame, so that the function calculation value may be obtained by substituting the first time information into the ratio change rate determination function, and the first scaling ratio corresponding to the current transition video frame may be determined according to the function calculation value and the second mapping relationship. Based on the same processing manner, the first scaling ratio corresponding to each transition video frame may be obtained.

Further, the first scaling ratio of the at least one transition video frame in the first transition video may be determined based on the total duration, the scaling ratio range, and the ratio change rate determination function in the following implementation: determining, for the at least one transition video frame, the accumulated duration corresponding to the transition video frame based on the preset frame rate and the display position of the transition video frame in the first transition video; and determining an input parameter ratio according to the accumulated duration and the total duration, to determine the change amplitude value based on the input parameter ratio and the ratio change rate determination function; and determining the first scaling ratio of the transition video frame based on the change amplitude value and the scaling ratio range.

In this embodiment, for each transition video frame in the first transition video, the first scaling ratio corresponding to the transition video frame is determined in the same manner. Here, any one of the transition video frames is taken as an example for description. The preset frame rate may be 50 frames per second, and the display position of the transition video frame in the first transition video may be the 20th display position, so that the accumulated duration T10 corresponding to the transition video frame is 400 milliseconds; the preset total duration of the first transition video is 2 seconds, and the input parameter ratio may be expressed as H=400 milliseconds per 2 seconds. Further, the change amplitude value may be determined according to the mapping relationship between the independent variable parameter range of the ratio change rate determination function and the input parameter ratio. For example, the independent variable parameter range of the ratio change rate determination function is (0, 1), the input parameter ratio is normalized according to the independent variable parameter range, and the input parameter to be input to the ratio change rate determination function may be obtained as 0.05. Further, 0.05 may be substituted into the ratio change rate determination function for calculation, and the obtained calculation result is the change amplitude value. Further, the first scaling ratio of the transition video frame may be obtained according to the change amplitude value, the maximum value of the ratio change rate determination function, and the maximum value of the scaling ratio range. This is because: change amplitude value/maximum value of the ratio change rate determination function=first scaling ratio/maximum value of the scaling ratio range. For the schematic diagram of the ratio change rate determination function, see FIG. 9. As shown in FIG. 9, the ratio change rate is small in the initial time period and the end time period of the ratio change rate determination function, and the ratio change rate is large in the middle time period of the size change function. In this manner, the first transition video determined according to the ratio change rate determination function may achieve the effect of slow fading in and out, and the stiffness of the transition may be reduced.

At step S340, perform sampling processing on the first image based on the first scaling ratio of the at least one transition video frame to obtain the transition video frame in the first transition video.

In this embodiment, for each transition video frame in the first transition video, the sampling processing is performed in the same manner. Here, any one of the transition video frames is taken as an example for description. For any transition video frame, the first image may be scaled up according to the first scaling ratio, and then the sampling processing is performed on the first image to obtain a certain transition video frame by using the alignment of the center point of the scaled-up first image with the center point of the first display region as a constraint. Based on the same processing manner, each transition video frame in the first transition video may be obtained.

Based on the preceding embodiments, the sampling processing may be performed on the first image based on the first scaling ratio of the at least one transition video frame to obtain the transition video frame in the first transition video in the following specific implementation: substituting, for the at least one sampling point on the first display region, the first texture coordinate of the sampling point and the first scaling ratio into a texture coordinate sampling function for processing to obtain the second texture coordinate of the sampling point; and performing sampling processing on the first image based on the second texture coordinate to obtain the transition video frame.

The first display region includes a plurality of sampling points, and the texture coordinate corresponding to each sampling point is the first texture coordinate.

The texture coordinate sampling function is a function expression for transforming the first texture coordinate. The second texture coordinate is the texture coordinate to be used for performing sampling processing on the first image.

In this embodiment, the first texture coordinate of the sampling point in the first display region is transformed by the first scaling ratio to obtain the second texture coordinate to be used for sampling the first image. In a specific implementation process, the value range of the abscissa in the texture coordinate system of the first display region is u∈[0, 1], and the value range of the ordinate in the texture coordinate system of the first display region is v∈[0, 1], that is, the original texture coordinate system may be expressed as: uv, u∈[0, 1], v∈[0, 1], and in order to ensure that the first image is scaled up based on the center point, the original texture coordinate system may be first mapped to the interval [−1,1] according to u′=2u−1, v′=2v−1. In this step, the first image is scaled up, which means that the sampling coordinate is to be scaled down. Based on this, the expression of the texture coordinate sampling function may be expressed as:

$${UV}_{n e w} = \frac{1}{2} ( \frac{2 uv - 1}{{s}^{′}} + 1 )$$

where UV_{new} represents the second texture coordinate, uv represents the first texture coordinate, and s′ represents the first scaling ratio. It should be particularly noted that the operations of adding 1 and multiplying by ½ in the texture coordinate sampling function are to map UV to [−1,1] and then map it back to the interval [0, 1] for ease of center scaling-up.

In this embodiment, for each sampling point in the first display region, the first texture coordinate of the current sampling point and the first scaling ratio may be substituted into the texture coordinate sampling function for calculation processing, so that the second texture coordinate of the current sampling point may be obtained. Further, the sampling processing is performed on the first image according to the second texture coordinate to read the pixel value adapted to the second texture coordinate in the first image, and the pixel value corresponding to each sampling point in the first display region may be obtained based on the same processing manner, so that a transition video frame may be obtained. A plurality of transition video frames may be obtained based on the same processing manner, and the first transition video may be obtained from the plurality of transition video frames.

At step S350, display the first image, the first transition video, and the second image in sequence to obtain the first effect video.

In the technical solution of the embodiment of the present disclosure, in response to that the first transition video is determined based on the second transition video determination manner, the scaling ratio range of the first image changing from the current height to the height consistent with the height of the second image is determined according to the first aspect ratio and the third aspect ratio, and the first scaling ratio of the at least one transition video frame in the first transition video is determined based on the preset total duration of the first transition video and the scaling ratio range, and the sampling processing is performed on the first image based on the first scaling ratio of the at least one transition video frame to obtain the transition video frame in the first transition video. In the technical solution of the embodiment of the present disclosure, by determining the scaling ratio range, the scaling-up rate of the first image may be quantitatively controlled, and the first effect video with gentle transition may be accurately and efficiently determined, thereby improving the coordination of the image aspect ratio of the first effect video.

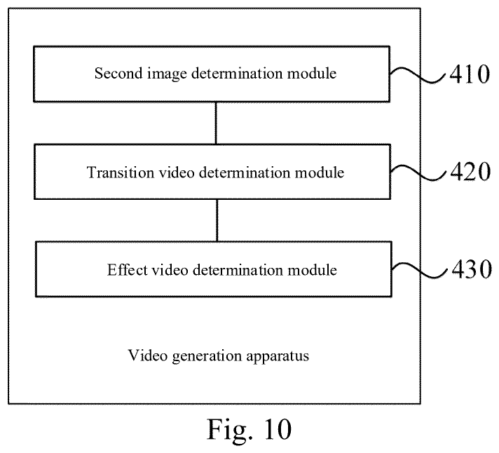

FIG. 10 is a schematic diagram of a structure of a video generation apparatus according to an embodiment of the present disclosure. As shown in FIG. 10, the apparatus includes a second image determination module 410, a transition video determination module 420, and an effect video determination module 430.

The second image determination module 410 is configured to receive a first image in response to a trigger operation for generating a first video and determine a second image associated with the first image, where picture content of the second image is related to picture content of the first image.

The transition video determination module 420 is configured to determine a first transition video from the first image to the second image according to image size data of the first image and image size data of the second image.

The effect video determination module 430 is configured to display the first image, the first transition video, and the second image in sequence to obtain a first effect video.

Based on the preceding optional technical solutions, optionally, the video generation apparatus further includes an image display module configured to render the first image to a first display region for display according to the image size data of the first image and canvas size data of the first display region, where the first display region is a canvas that displays the first image and the second image.

Based on the preceding optional technical solutions, optionally, the image display module is further configured to, in response to an event that a first aspect ratio in the image size data of the first image is less than a second aspect ratio in the canvas size data, crop the first image according to the second aspect ratio and then render the first image onto the first display region; and in response to an event that the first aspect ratio is greater than or equal to the second aspect ratio, render the first image onto the first display region and preset a pixel point on the first display region where the first image is not presented to a preset pixel value, where a center coordinate of the first image is aligned with a center coordinate of the first display region.

Based on the preceding optional technical solutions, optionally, the first transition video is related to a first transition video determination manner, the first transition video is to display a preset pixel value from a top of the first image in a first direction and display the preset pixel value from a bottom of the first image in a second direction, and the first transition video determination manner corresponds to the first aspect ratio of the first image being less than a third aspect ratio of the second image.

Based on the preceding optional technical solutions, optionally, the first transition video is related to a second transition video determination manner, the first transition video is a video in which a local area of the first image is sequentially magnified, and the second transition video determination manner corresponds to the first aspect ratio of the first image being greater than or equal to the third aspect ratio of the second image.

Based on the preceding optional technical solutions, optionally, the video generation apparatus further includes an animation effect display module configured to display a first preset animation effect, where the preset animation effect is related to a style type of the second image.

Based on the preceding optional technical solutions, optionally, the video generation apparatus further includes an effect video update module configured to display the second image according to a second preset animation effect to update the first effect video.

Based on the preceding optional technical solutions, optionally, the transition video determination module 420 includes a first transition video determination unit and a second transition video determination unit.

Based on the preceding optional technical solutions, optionally, the first transition video determination unit includes a gradient range determination subunit and a first transition video determination subunit. The gradient range determination subunit is configured to determine a gradient size range of the first image according to the third aspect ratio, a second aspect ratio of the first display region, and a first function, where the gradient size range is used for representing a range of change from a top of the first image in a first direction and a range of change from a bottom of the first image in a second direction, and a pixel value in the range of change is a preset pixel value.

The first transition video determination subunit is configured to process the first image based on the gradient size range to obtain the first transition video.

Based on the preceding optional technical solutions, optionally, the first transition video determination subunit is further configured to determine a first gradient size corresponding to at least one transition video frame in the first transition video based on the gradient size range, a preset frame rate, and a size change function; and process the first image based on the first gradient size corresponding to the at least one transition video frame to obtain the first transition video.

Based on the preceding optional technical solutions, optionally, the gradient range determination subunit is further configured to, for the at least one transition video frame, determine an accumulated duration of the transition video frame based on the preset frame rate and a display position of the transition video frame in the first transition video; determine a first value to be input to the first size function based on the accumulated duration, a preset total duration of the first transition video, and a parameter range of the size change function; and substitute the first value into the size change function to determine the first gradient size of the transition video frame.

Based on the preceding optional technical solutions, optionally, the second transition video determination unit includes a scaling range determination subunit, a first proportion determination subunit, and a transition video frame determination subunit.

The scaling range determination subunit is configured to determine a scaling ratio range of the first image changing from a current height to a height consistent with a height of the second image according to the first aspect ratio and the third aspect ratio.

The first proportion determination subunit is configured to determine a first scaling ratio of at least one transition video frame in the first transition video based on a preset total duration of the first transition video and the scaling ratio range.

The transition video frame determination subunit is configured to perform sampling processing on the first image based on the first scaling ratio of the at least one transition video frame to obtain a transition video frame in the first transition video.

Based on the preceding optional technical solutions, optionally, the first proportion determination subunit is further configured to determine the first scaling ratio of the at least one transition video frame in the first transition video based on the total duration, the scaling ratio range, and a ratio change rate determination function.

Based on the preceding optional technical solutions, optionally, the first proportion determination subunit is further configured to, for the at least one transition video frame, determine an accumulated duration corresponding to the transition video frame based on a preset frame rate and a display position of the transition video frame in the first transition video; and determine an input parameter ratio based on the accumulated duration and the total duration to determine a change amplitude value based on the input parameter ratio and the ratio change rate determination function; and determine the first scaling ratio of the transition video frame based on the change amplitude value and the scaling ratio range.

Based on the preceding optional technical solutions, optionally, the transition video frame determination subunit is further configured to, for the at least one sampling point on the first display region, substitute a first texture coordinate of the sampling point and the first scaling ratio into a texture coordinate sampling function for processing to obtain a second texture coordinate of the sampling point; and perform sampling processing on the first image based on the second texture coordinate to obtain the transition video frame.

In the technical solution of the embodiments of the present disclosure, after receiving the first image in response to the trigger operation for generating the first video and determining the second image associated with the first image, the first transition video for switching from displaying the first image to the second image may be determined according to the image size data of the first image and the second image; and then the first image, the first transition video, and the second image are displayed in sequence to obtain the first effect video. In this manner, the first transition video adaptable to the first image and the second image may be determined according to the image size data of the first image and the second image, so that the smooth transition of the picture proportions may be achieved when the first image is transited to the second image, thereby improving the coordination of the picture content, and solving the problem of poor display effect of the picture content caused by the sudden change of the picture proportions when directly displayed in the prior art based on the first image and the second image.

The video generation apparatus according to the embodiments of the present disclosure may perform the video generation method according to any embodiment of the present disclosure, and has corresponding functional modules and beneficial effects for performing the method.

It should be noted that the units and modules included in the preceding apparatus are just divided according to functional logic but are not limited to such division, as long as the corresponding functions may be implemented. Additionally, the specific names of the functional units are just for distinguishing between each other but not to limit the protection scope of the embodiments of the present disclosure.

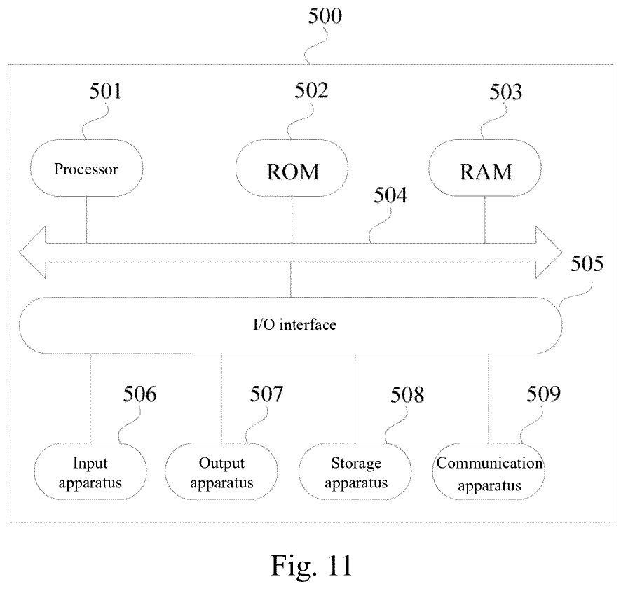

FIG. 11 is a schematic diagram of a structure of an electronic device according to an embodiment of the present disclosure. Reference is made to FIG. 11 below, which illustrates a schematic diagram of a structure of an electronic device 500 (such as a terminal device or a server in FIG. 11) suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), and a vehicle-mounted terminal (such as a vehicle navigation terminal), and a fixed terminal such as a digital TV and a desktop computer. The electronic device shown in FIG. 11 is merely an example, and should not impose any limitation on the function and scope of use of the embodiments of the present disclosure.

As shown in FIG. 11, the electronic device 500 may include a processor 501 (such as a central processing unit and a graphics processor), which may perform various suitable actions and processing according to a program stored in a read-only memory (ROM) 502 or a program loaded from a storage apparatus 508 into a random access memory (RAM) 503. The RAM 503 further stores various programs and data required for operations of the electronic device 500. The processing apparatus 501, the ROM 502, and the RAM 503 are interconnected by means of a bus 504. An editing/output (I/O) interface 505 is also connected to the bus 504.

Usually, the following apparatuses may be connected to the I/O interface 505: an input apparatus 506 including, for example, a touch screen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a magnetic tape and a hard disk; and a communication apparatus 509. The communication apparatus 509 may allow the electronic device 500 to perform wireless or wired communication with other devices to exchange data. Although FIG. 11 shows the electronic device 500 having various apparatuses, it should be understood that it is not necessary to implement or provide all the apparatuses shown. More or fewer apparatuses may be implemented or provided alternatively.

In particular, according to the embodiments of the present disclosure, the process described above with reference to the flowcharts may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network through the communication apparatus 509, or may be installed from the storage apparatus 508, or may be installed from the ROM 502. When the computer program is executed by the processing apparatus 501, the preceding functions defined in the method of the embodiments of the present disclosure are executed.

The names of messages or information exchanged between a plurality of apparatuses in implementations of the present disclosure are only for illustrative purposes, and are not intended to limit the scope of these messages or information.

The electronic device provided in the embodiments of the present disclosure belongs to the same inventive concept as the video generation method provided in the preceding embodiments. For the technical details not described in detail in the embodiments of the present disclosure, reference may be made to the preceding embodiments, and the embodiments have the same beneficial effects as the preceding embodiments.

An embodiment of the present disclosure provides a computer storage medium having a computer program stored thereon, where the program, when executed by a processor, implements the video generation method provided in the preceding embodiments.

It should be noted that the preceding computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, which may be used by or used in combination with an instruction execution system, apparatus, or device. In the present disclosure, the computer-readable signal medium may include a data signal propagated on a baseband or as a part of a carrier wave, and computer-readable program code is carried in the data signal. The data signal propagated in this manner may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including but not limited to, a wire, an optical cable, an RF (radio frequency), or any suitable combination thereof.

In some implementations, clients and servers may communicate using any currently known or future developed network protocol, such as HTTP (Hyper Text Transfer Protocol), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device or may exist alone without being assembled into the electronic device.

The computer-readable medium carries one or more programs that, when executed by the electronic device, cause the electronic device to:
receive a first image in response to a trigger operation for generating a first video and determine a second image associated with the first image, where picture content of the second image is related to picture content of the first image;
determine a first transition video from the first image to the second image according to image size data of the first image and the second image; and
display the first image, the first transition video, and the second image in sequence to obtain a first effect video.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of involving the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which includes one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented in a software manner or in a hardware manner. The name of a unit does not constitute a limitation on the unit itself under certain circumstances.

The functions described above herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electrical, magnetic, optical, electromagnetic, infrared, or semiconductor system, apparatus, or device, or any suitable combination thereof. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The preceding description is merely better embodiments of the present disclosure and an explanation of the technical principles employed. Those skilled in the art should understand that the scope of disclosure involved in the present disclosure is not limited to the technical solutions formed by the specific combination of the preceding technical features, and should also cover other technical solutions formed by any combination of the preceding technical features or equivalent features thereof without departing from the preceding concept of disclosure. For example, a technical solution formed by a replacement of the preceding features with technical features with similar functions disclosed in the present disclosure (but not limited thereto) also falls within the scope of the present disclosure.

Additionally, although the various operations are depicted in a particular order, it should not be understood as requiring that such operations are performed in the particular order shown or in a sequential order. Under certain circumstances, multitasking and parallel processing may be advantageous. Likewise, although the preceding discussion includes several specific implementation details, these should not be interpreted as limitations on the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the present subject matter has been described in language specific to structural features and/or logical actions of the method, it should be understood that the subject matter defined in the appended claims is not necessarily limited to the specific features or actions described above. Conversely, the specific features and actions described above are merely exemplary forms for implementing the claims.

1. A video generation method, comprising:
receiving a first image in response to a trigger operation for generating a first video and determining a second image associated with the first image, wherein picture content of the second image is related to picture content of the first image;
determining a first transition video from the first image to the second image according to image size data of the first image and image size data of the second image; and
displaying the first image, the first transition video, and the second image in sequence to obtain a first effect video.

2. The video generation method according to claim 1, wherein after the receiving a first image, the method further comprises:
rendering the first image to a first display region for display according to the image size data of the first image and canvas size data of the first display region,
wherein the first display region is a canvas that presents the first image and the second image.

3. The video generation method according to claim 2, wherein the rendering the first image to a first display region according to the image size data of the first image and canvas size data of the first display region, comprises:
in response to an event that a first aspect ratio in the image size data of the first image is less than a second aspect ratio in the canvas size data, cropping the first image according to the second aspect ratio and then rendering the first image onto the first display region; and
in response to an event that the first aspect ratio is greater than or equal to the second aspect ratio, rendering the first image onto the first display region and presetting a pixel point on the first display region where the first image is not presented to a preset pixel value,
wherein a center coordinate of the first image is aligned with a center coordinate of the first display region.

4. The video generation method according to claim 1, wherein the first transition video is related to a first transition video determination manner, the first transition video is to display a preset pixel value from a top of the first image in a first direction and display the preset pixel value from a bottom of the first image in a second direction, and the first transition video determination manner corresponds to a first aspect ratio of the first image being less than a third aspect ratio of the second image.

5. The video generation method according to claim 1, wherein the first transition video is related to a second transition video determination manner, the first transition video is a video in which a local area of the first image is sequentially magnified, and the second transition video determination manner corresponds to a first aspect ratio of the first image being greater than or equal to a third aspect ratio of the second image.

6. The video generation method according to claim 1, wherein in a process of displaying the first transition video in the first effect video, the method further comprises:
displaying a first preset animation effect, wherein the preset animation effect is related to a style type of the second image.

7. The video generation method according to claim 1, wherein after displaying the second image, the method further comprises:
displaying the second image according to a second preset animation effect to update the first effect video.

8. The video generation method according to claim 4, wherein determining the first transition video based on the first transition video determination manner, comprises:
determining a gradient size range of the first image according to the third aspect ratio, a second aspect ratio of the first display region, and a first function, wherein the gradient size range is used for representing a range of change from a top of the first image in a first direction and a range of change from a bottom of the first image in a second direction, and a pixel value in the range of change is a preset pixel value; and
processing the first image based on the gradient size range to obtain the first transition video.

9. The video generation method according to claim 8, wherein the processing the first image based on the gradient size range to obtain the first transition video, comprises:
determining a first gradient size corresponding to at least one transition video frame in the first transition video based on the gradient size range, a preset frame rate, and a size change function; and
processing the first image based on the first gradient size corresponding to the at least one transition video frame to obtain the first transition video.

10. The video generation method according to claim 9, wherein the determining a first gradient size corresponding to at least one transition video frame in the first transition video based on the gradient size range, a preset frame rate, and a size change function, comprises:
for the at least one transition video frame, determining an accumulated duration of the transition video frame based on the preset frame rate and a display position of the transition video frame in the first transition video;
determining a first value to be input to the first size function based on the accumulated duration, a preset total duration of the first transition video, and a parameter range of the size change function; and
substituting the first value into the size change function to determine the first gradient size of the transition video frame.

11. The video generation method according to claim 5, wherein determining the first transition video based on the second transition video determination manner, comprises:
determining a scaling ratio range of the first image changing from a current height to a height consistent with a height of the second image according to the first aspect ratio and the third aspect ratio;
determining a first scaling ratio of at least one transition video frame in the first transition video based on a preset total duration of the first transition video and the scaling ratio range; and
performing sampling processing on the first image based on the first scaling ratio of the at least one transition video frame to obtain a transition video frame in the first transition video.

12. The video generation method according to claim 11, wherein the determining a first scaling ratio of the at least one transition video frame in the first transition video based on the preset total duration of the first transition video and the scaling ratio range, comprises:
determining the first scaling ratio of the at least one transition video frame in the first transition video based on the total duration, the scaling ratio range, and a ratio change rate determination function.

13. The video generation method according to claim 12, wherein the determining the first scaling ratio of the at least one transition video frame in the first transition video based on the total duration, the scaling ratio range, and a ratio change rate determination function, comprises:
for the at least one transition video frame, determining an accumulated duration corresponding to the transition video frame based on a preset frame rate and a display position of the transition video frame in the first transition video; and
determining an input parameter ratio based on the accumulated duration and the total duration to determine a change amplitude value based on the input parameter ratio and the ratio change rate determination function; and
determining the first scaling ratio of the transition video frame based on the change amplitude value and the scaling ratio range.

14. The video generation method according to claim 11, wherein the performing sampling processing on the first image based on the first scaling ratio of the at least one transition video frame to obtain a transition video frame in the first transition video, comprises:
for at least one sampling point on the first display region, substituting a first texture coordinate of the sampling point and the first scaling ratio into a texture coordinate sampling function for processing to obtain a second texture coordinate of the sampling point; and
performing sampling processing on the first image based on the second texture coordinate to obtain the transition video frame.

15. An electronic device, comprising:
one or more processors; and
a storage apparatus, configured to store one or more programs,
wherein the one or more programs, when executed by the one or more processors, cause the one or more processors to implement a video generation method,
wherein the video generation method comprises:
receiving a first image in response to a trigger operation for generating a first video and determining a second image associated with the first image, wherein picture content of the second image is related to picture content of the first image;
determining a first transition video from the first image to the second image according to image size data of the first image and image size data of the second image; and
displaying the first image, the first transition video, and the second image in sequence to obtain a first effect video.

16. The electronic device according to claim 15, wherein after the receiving a first image, the method further comprises:
rendering the first image to a first display region for display according to the image size data of the first image and canvas size data of the first display region,
wherein the first display region is a canvas that presents the first image and the second image.

17. The electronic device according to claim 16, wherein the rendering the first image to a first display region according to the image size data of the first image and canvas size data of the first display region, comprises:
in response to an event that a first aspect ratio in the image size data of the first image is less than a second aspect ratio in the canvas size data, cropping the first image according to the second aspect ratio and then rendering the first image onto the first display region; and
in response to an event that the first aspect ratio is greater than or equal to the second aspect ratio, rendering the first image onto the first display region and presetting a pixel point on the first display region where the first image is not presented to a preset pixel value,
wherein a center coordinate of the first image is aligned with a center coordinate of the first display region.

18. The electronic device according to claim 15, wherein the first transition video is related to a first transition video determination manner, the first transition video is to display a preset pixel value from a top of the first image in a first direction and display the preset pixel value from a bottom of the first image in a second direction, and the first transition video determination manner corresponds to a first aspect ratio of the first image being less than a third aspect ratio of the second image.

19. The electronic device according to claim 15, wherein the first transition video is related to a second transition video determination manner, the first transition video is a video in which a local area of the first image is sequentially magnified, and the second transition video determination manner corresponds to a first aspect ratio of the first image being greater than or equal to a third aspect ratio of the second image.

20. A non-transitory storage medium comprising computer-executable instructions that, when executed by a computer processor, are configured to perform a video generation method,
wherein the video generation method comprises:
receiving a first image in response to a trigger operation for generating a first video and determining a second image associated with the first image, wherein picture content of the second image is related to picture content of the first image;
determining a first transition video from the first image to the second image according to image size data of the first image and image size data of the second image; and
displaying the first image, the first transition video, and the second image in sequence to obtain a first effect video.
